(19) United States
(12) Patent Application Publication
(10) Pub. No.: US 2004/0219828 A1
(43) Pub. Date: Nov. 4, 2004

(54) Electric power bar

(76) Inventor: Gary A. Pulyk, Mannville (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/809,039

(22) Filed: Mar. 24, 2004

(30) Foreign Application Priority Data
Sep. 20, 2002 (CA) 2,404,542

(51) Int. Cl. H01R 4/50

(52) U.S. Cl. 439/535

(57) ABSTRACT

An electric power bar which includes a body and an electrical cord adapted to plug the body into an electrical outlet of a building. The body has one or more female receptacles which receive power via the electrical cord. The female receptacles are adapted to receive a plug from a computer or ancillary equipment whereby power is supplied to the computer or the ancillary equipment. The body also has incorporated within in it a communications module which serves as a conduit for sending and receiving messages. The body has at least one of an Ethernet receptacle, an universal serial bus receptacle, or a telephone jack receptacle in communication with the communications module, so as to enable a computer to be connected to the communications module.

### CROSS-REFERENCE TO RELATED APPLICATION

This application is a continuation-in-part of prior PCT Application No. PCT/CA03/013888, filed Sep. 19, 2003, which designated the United States of America and claimed priority from prior Canadian Application No. 2,404,542, filed in Canada on Sep. 20, 2002, priority from the filing date of which is hereby claimed under 35 U.S.C. § 120.

### FIELD OF THE INVENTION

The present invention relates to an electric power bar and, more particularly, an electric power bar intended for use with a computer.

### BACKGROUND OF THE INVENTION

Electric power bars are commonly used with computers to provide electric power to the computers and ancillary equipment such as printers and scanners. Preferably the electric power bar has some surge protection, to protect the computer from damage as a result of power surges. Such electric power bars are not specific to computers, and are also used for a variety of other applications having nothing to do with computers.

### SUMMARY OF THE INVENTION

What is required is an electric power bar which is specifically adapted for use with computers and ancillary equipment.

According to the present invention there is provided an electric power bar which includes a body and an electrical cord adapted to plug the body into an electrical outlet of a building. The body has one or more female receptacles which receive power via the electrical cord. The female receptacles are adapted to receive a plug from a computer or ancillary equipment whereby power is supplied to the computer or the ancillary equipment. The body also has incorporated within in it a communications module which serves as a conduit for sending and receiving messages. The body has at least one of an Ethernet receptacle, a universal serial bus receptacle, or a telephone jack receptacle in communication with the communications module, so as to enable a computer to be connected to the communications module.

In order to connect a computer at the present time a number of adaptors are required. The electric power bar, as described above, replaces these with a single body. It is envisaged that communications module for the electric power bar, described above, will include a phone line in receptacle and a phone line out receptacle. It will be appreciated, however, that as wireless networks become more common the phone line in or the phone line out receptacles could be replaced with wireless components.

The electric power bar, as described above, is viewed as being ideal for persons wishing to set up home phone networks (HPN) or very high data rate digital subscriber lines (VDSL).

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an electric power bar constructed in accordance with the teachings of the present invention.

FIG. 2 is a perspective view of the electric power bar illustrated in FIG. 1 connected to a computer.

FIG. 3 is an end elevation view of the electric power bar illustrated in FIG. 1.

FIG. 4 is a block diagram of the circuitry of the electric power bar.

FIG. 5 is a bottom perspective view of the electric power bar illustrated in FIG. 1.

### DETAILED DESCRIPTION OF THE PREFERRED EMBODIMENT

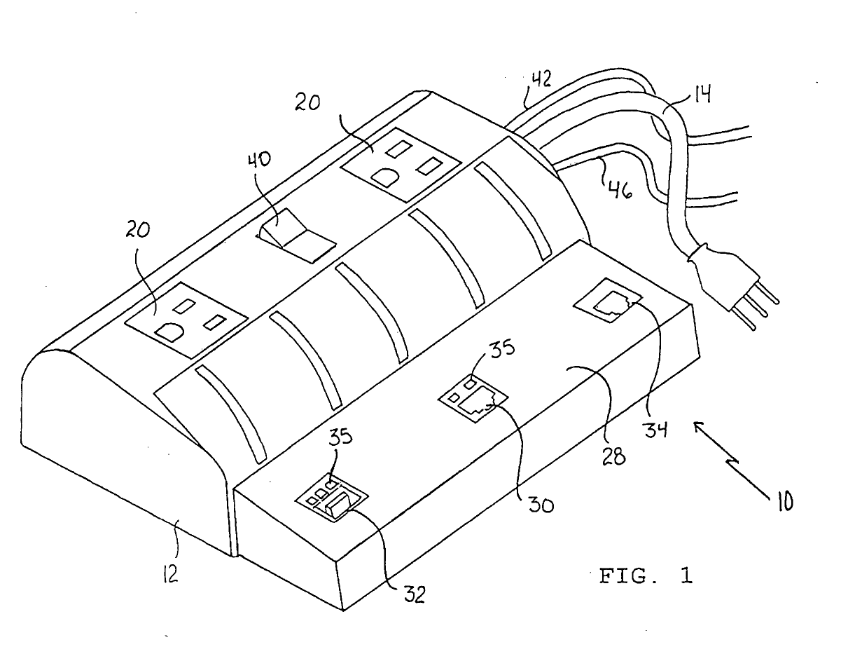

The preferred embodiment, an electric power bar generally identified by reference numeral 10, will now be described with reference to FIGS. 1 through 3.

Structure and Relationship of Parts:

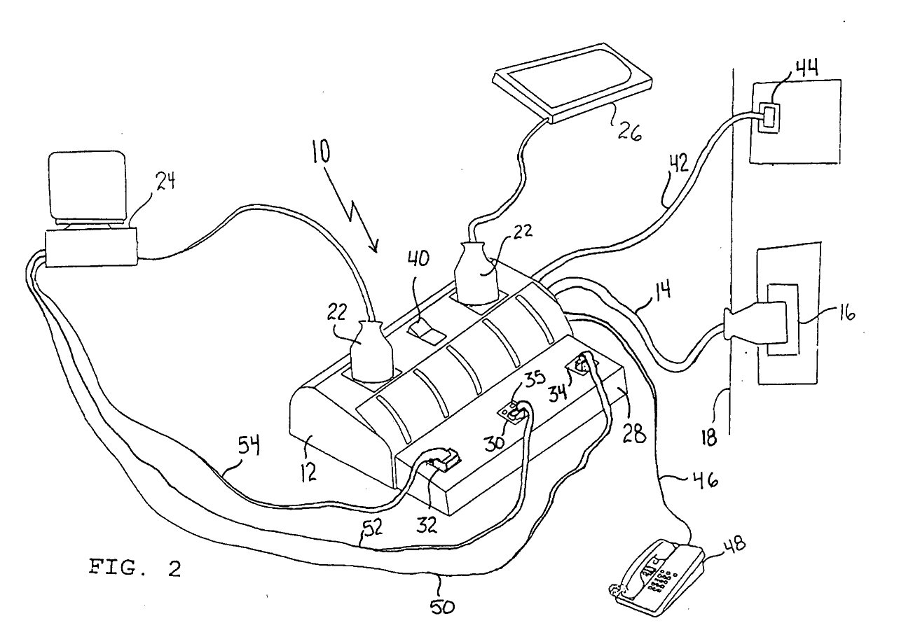

Referring to FIG. 1, there is provided an electric power bar 10, which includes a body 12. Referring to FIG. 2, an electrical cord 14 is provided that is adapted to plug body 12 into an electrical outlet 16 of a building 18. Referring to FIG. 1, body 12 has several female receptacles 20 which receive power via electrical cord 14. Referring to FIG. 2, each of female receptacles 20 is adapted to receive a plug 22 from one of a computer 24 or ancillary equipment such as a scanner 26 whereby power is supplied to computer 24 and scanner 26. It will be appreciated that instead of scanner 26 other types of ancillary equipment such as printers, or other external device requiring power can also be plugged into one of female receptacles 20.

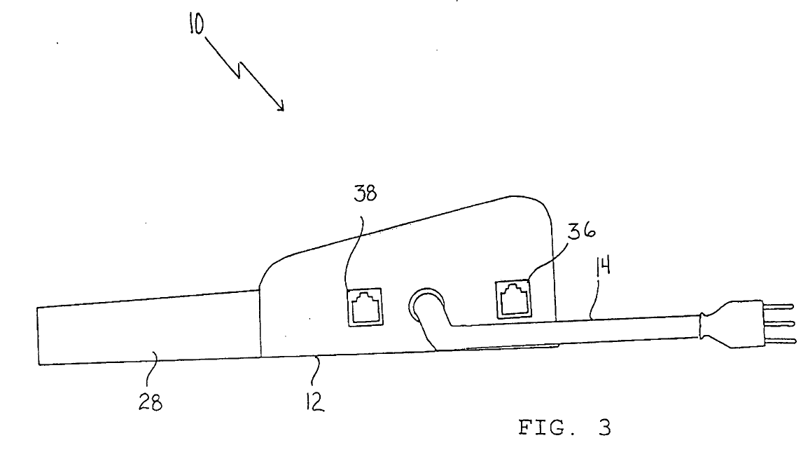

Referring to FIG. 1, body 12 has a communications module 28, whereby communications module 28 serves as a conduit for sending and receiving messages. Body 12 has an ethernet receptacle 30, an universal serial bus receptacle 32, and a telephone jack receptacle 34 in communication with communications module 28, whereby computer 24 can be connected in one of several different ways to communications module 28. LED lights 35 indicate the operating status of ethernet receptacle 30 and universal serial bus (USB) receptacle 32, as well as electric power bar 10. Referring to FIG. 3, communications module 28 also has a phone line in receptacle 36 and a phone line out receptacle 38. Referring to FIG. 1, a power switch 40 is provided for turning power bar 10 on and off.

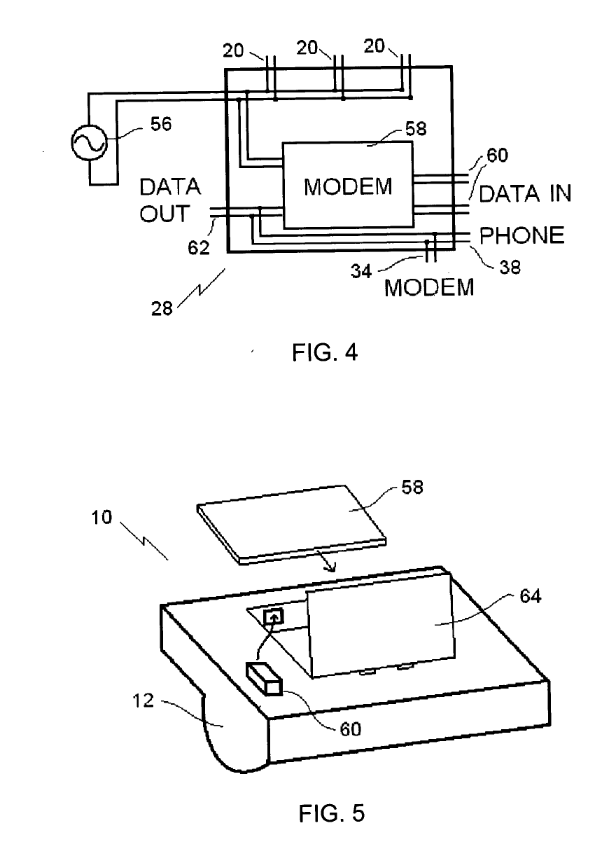

Referring to FIG. 4, a block diagram of communications module 28 is shown. A power source 56 provides female receptacles 20 and modem 58 with power. Modem 58 is connected to data ports 60 and a data port 62 that can be connected to a network. Data ports 60 may include ports such as ethernet receptacle 30, and USB receptacle 32, or other types of receptacles, as required by the situation and as know in the art. USB receptacle 32 allows a user to connect to the network through a USB port on the computer, while ethernet receptacle 30 allows a user to connect through a network card on the computer. As an example of another port, a coax receptacle may also be used, which may also be used to connect to, for example, a television.

Referring to FIG. 5, power bar 10 is designed such that ports 60 and 62, as well as modem 58 are replaceable to accommodate the different situations that may be encountered. For example, replaceable modems may be used to connect different ports such as USB, ethernet, or coax to different network protocols, such as HPNA 1.1 or 3.0, or VDSL, allowing the power bar 10 to be upgradeable and versatile. A means of replacing modem 58 and ports 60 and 62 (only port 60 is shown) is depicted in FIG. 5 by way of example, and it will be understood that other types of access are possible. Housing 12 is shown upside down to allow access to an access panel 64, with modem 58 and port 60 being inserted. Access panel 64 may also be located on the side or end of housing 12, and may not swing on hinges, but rather slide to allow access, for example.

The circuitry involved in the modems that may be required according to the situation are known in the art, and the necessary components can be purchased from distributors. FIG. 4 is an example of circuitry intended for use over the existing telephone wiring in a building. In this situation, phone receptacle 34 as well as a receptacle for a modem within the computer are included and are connected directly to port 62, as the information from these sources require no further processing.

Operation:

The use and operation of electric power bar generally identified by reference numeral 10, will now be described with reference to FIGS. 1 through 3. Electric power bar 10, as described above, is a more versatile and convenient way to hook up computer 24 thereby eliminating the need for numerous adaptors. Referring to FIG. 2, power can be supplied to computer 24 and ancillary equipment such as a scanner 26 by plugging computer and scanner into female receptacles 20 of power bar 10. Communications module 28 of electric power bar 10 is able to function as a home phone network (HPN) ethernet bridge which enables computer 24 to access communications networks through existing telephone wires via communications module 28 of electric power bar 10. As a result, the need to rewire network cables or share network resources in building 18 is eliminated. Because electric power bar 10 uses plug and play technology, no software configuration is required. Furthermore, electric power bar 10 complies with most network protocols.

Referring to FIG. 2, to use electric power bar 10, electrical cord 14 which supplies power to body 12, is plugged into electrical outlet 16 of building 18. Power switch 40 is switched to the on position. Plugs 22 from computer 24 and from scanner 26 are plugged into each of female receptacles 20 to supply power to computer 24 and scanner 26, or if desired to other peripheral devices. Telephone cord 42 from a telephone outlet 44 of building 18 is plugged into phone line in receptacle 36 illustrated in FIG. 3, to allow communications module 28 to connect to existing communications network.

Referring to FIG. 2, communications module 28 of electric power bar 10 permits computer 24 to be connected to other communications networks in a variety of ways. For example, computer 24 can be connected to communications module 28 of electrical power bar 10 by plugging ethernet cable 52 from computer 24 into ethernet receptacle 30 or by using a universal serial bus cable 54 to connect computer 24 to universal serial bus receptacle 32. Computer 24 is then able to access communications networks through existing telephone wires via communications module 28 of electric power bar 10.

If the user prefers to a dial up connection, a telephone cord 50 can be plugged into a modem of computer 24 and then plugged into telephone jack receptacle 34 of communications module 28. Referring to FIG. 2, furthermore, a telephone 48 can still be used for voice communications, by plugging a cord 46 from telephone 48 into phone line out receptacle 38 illustrated in FIG. 3.

While the illustrated embodiment shows communication module 28 as having only one telephone jack receptacle 34, ethernet receptacle 30, and universal serial bus receptacle 32, it will be appreciated that additional telephone jack receptacles 34, ethernet receptacles 30, and universal serial bus receptacles 32 could also be incorporated into communications module 28 thereby enabling electric power bar 10 to have more versatility. This enhances the ways in which computer 24 can be connected to communication networks or ancillary devices. This is especially beneficial for setting up home phone networks (HPN) and very high data rate digital subscriber lines (VDSL). It is particularly suited to buildings 18 such as hotels, where it is not cost effective or practical to rewire for communications network access, as with power bar 10, computer 24 is able to access communications networks through existing telephone wires of building 18 via communications module 28 of electric power bar 10.

It will also be appreciated that with the addition of a dual protocol switch, electric power bar 10, enables 2 users to share access to the internet via ethernet receptacle 30, or universal serial bus receptacle 32.

It will also be appreciated that with the increasing popularity of wireless networks, phone line in receptacle 36 and a phone line out receptacle 38 could be replaced with wireless components.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. An electric power bar, comprising:
a body;
an electrical cord adapted to plug the body into an electrical outlet of a building;
the body having at least one female receptacle which receives power via the electrical cord, the female receptacle being adapted to receive a plug from one of a computer or ancillary equipment whereby power is supplied to the computer or the ancillary equipment;
the body having a communications module, whereby the communications module serves as a conduit for sending and receiving messages; and
the body having at least one of an Ethernet receptacle, an universal serial bus receptacle, or a telephone jack receptacle in communication with the communications module, whereby a computer is connected to the communications module.

2. The electric power bar as defined in claim 1, wherein the communications module has a phone line in receptacle and a phone line out receptacle.

3. The electric power bar as defined in claim 1, wherein the body has an Ethernet receptacle, an universal serial bus receptacle, and a telephone jack receptacle all in communication with the communications module, whereby a computer can be connected in one of several different ways to the communications module.

4. The electric power bar as defined in claim 1, wherein the communications module comprises a replaceable modem.
